(19) United States
(12) Patent Application Publication
(10) Pub. No.: US 2007/0098912 A1
(43) Pub. Date: May 3, 2007

(54) Method for producing functionally graded coatings using cold gas-dynamic spraying

(75) Inventors: Derek Raybould, Denville, NJ (US); Timothy R. Duffy, Chandler, AZ (US); Margaret M. Floyd, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/261,063

(22) Filed: Oct. 27, 2005

(51) Int. Cl. B05D 1/08; H05H 1/26

(52) U.S. Cl. 427/446

(57) ABSTRACT

A method is provided for forming a graded coating on a surface of a substrate. The method comprises the step of cold gas-dynamic spraying powder mixtures on the substrate surface to form the graded coating thereon. The method does not distort the substrate and does not require the use of an apparatus that needs to be stopped and re-started each time the composition of the graded coating changes. Moreover, the method is generally inexpensive, efficient, and yields high quality graded coatings.

### TECHNICAL FIELD

The present invention relates to coating substrates, such as gas turbine engine components, with a coating having high strength and hardness and, more particularly, to methods of forming a graded coating on the substrate.

### BACKGROUND

Turbine engines are used as the primary power source for aircraft, in the forms of jet engines and turboprop engines, as auxiliary power sources for driving air compressors, hydraulic pumps, on aircraft, and as stationary power supplies, such as backup electrical generators for hospitals and the like. The same basic power generation principles apply for all these types of turbine engines. Compressed air is mixed with fuel and burned, and the expanding hot combustion gases are directed against stationary turbine vanes in the engine. The vanes turn the high velocity gas flow partially sideways to impinge on the turbine blades mounted on a rotationally mounted turbine disk or wheel.

The force of the impinging gas causes the turbine disk to spin at high speeds and to produce power. Some engines use this power to turn a propeller, electrical generator, or other devices, while jet propulsion engines use this power to draw more air into the engine. When the high velocity combustion gas is passed out of the aft end of a jet turbine, forward thrust is created. Thus, during operation of the turbine engine, these components are subjected to stress loadings and high heat (often in excess of 2000° F.). The high stress and heat can cause erosion, oxidation, corrosion, thermal fatigue cracks and/or foreign object damage in the component, resulting in unacceptably high rates of degradation.

To protect the components from the above-mentioned environments, graded coatings may be included thereon. Conventionally, graded coatings have been deposited onto the component using one of various thermal spraying techniques, for example, low pressure plasma spraying, high velocity oxygen fuel thermal spraying, arc-plasma spraying, and electric wire arc spraying; however, these techniques suffer from certain drawbacks, which have made them expensive and limited their use. For example, because the coating material and component are both heated during the deposition process, the component may be more prone to distortion. Additionally, a thermal spraying apparatus typically needs to be stopped and re-started each time the composition of the coating changes. As a result, the coating may be deposited layer by layer and physical differences between each of the layers may promote cracking. Also, spraying mixtures of powders to obtain a gradual transition from one layer to the next is relatively difficult to achieve due to the different temperatures (spray conditions) required for depositing each powder. Moreover, thermal spraying is generally costly and time-consuming to implement, especially when depositing more than one layer.

Hence, there is a need for a spraying method that is capable of efficiently and cost-effectively producing a wear and oxidation-resistant coating that has high strength or hardness. Preferably, the method is capable of producing a graded coating that experiences little to no cracking. There is also a need for a spraying method by which graded coatings can be uniformly and thoroughly applied at temperatures that will not distort the coating component.

### BRIEF SUMMARY

The present invention provides a method of forming a graded coating on a surface of a substrate. The method comprises the step of cold gas-dynamic spraying powder mixtures on the substrate surface to form the graded coating thereon.

In another exemplary embodiment, the method comprises cold gas-dynamic spraying a first powder mixture on the substrate surface, the first powder mixture formulated to form a first portion of the graded coating and comprising a first component and a second component. Additionally, the method includes gradually decreasing the first component and increasing the second component to form additional powder mixtures, while cold gas-dynamic spraying the additional powder mixtures over the portion of the graded coating to form a second portion of the graded coating.

In still another exemplary embodiment, the method comprises the step of cold gas-dynamic spraying a first powder mixture on the substrate surface to form a first portion of the graded coating. The method also includes decreasing a first component of the first powder mixture and increasing a second component of the first powder mixture to form additional powder mixtures, while cold gas-dynamic spraying the additional powder mixtures on the substrate surface over the first layer to form a second portion of the graded coating. Additionally, the method includes repeating the step of decreasing and cold-gas spraying the additional powder mixtures over the substrate to form other portions of the graded coating until a top portion having a predetermined composition is formed.

Other independent features and advantages of the preferred method will become apparent from the following detailed description, taken in conjunction with the accompanying drawings which illustrate, by way of example, the principles of the invention.

### BRIEF DESCRIPTION OF THE DRAWINGS

FIG. 1 is a cross sectional view of an exemplary substrate having a graded coating formed thereon;

FIG. 2 is a flow diagram of an exemplary method of forming a graded coating onto a substrate; and

FIG. 3 is a schematic view of an exemplary cold gas-dynamic spray apparatus in accordance with an exemplary embodiment.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

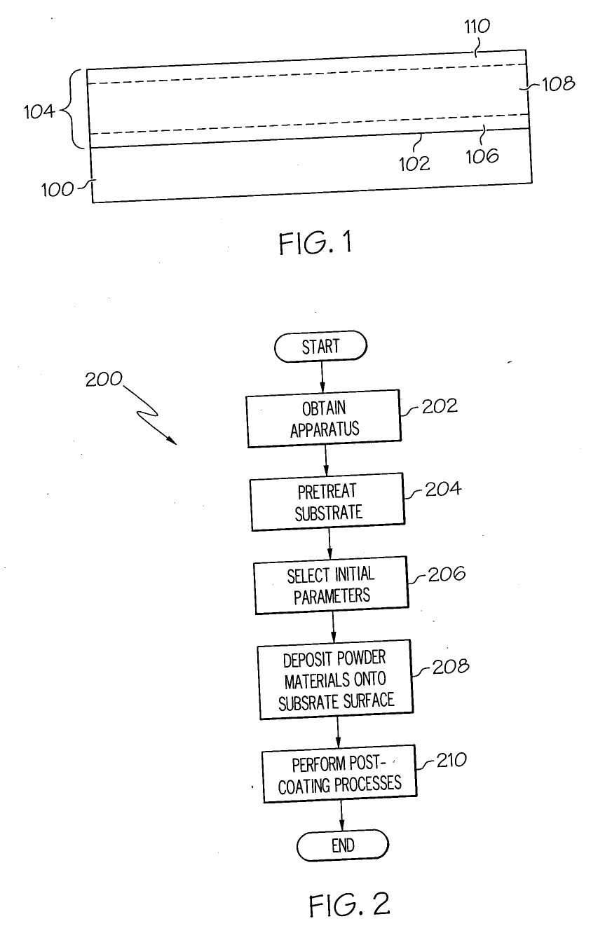

Turning now to FIG. 1, an exemplary substrate 100 having a graded coating 104 formed over its surface 102 is shown. The substrate 100 may be any one of numerous components, such as a turbine blade or disk, that may need a graded coating formed thereon. The graded coating 104 preferably includes a first section 106 having a first composition, a second section 108 wherein the first composition gradually changes into a second composition, and a third section 110 having the second composition. It will be appreciated that although each of the sections are delineated by dotted lines, the sections preferably blend into each other and the borders between the sections are virtually indistinguishable, having no sharp transitions.

FIG. 2 depicts a flow diagram of a method 200 of forming the graded coating 104 on the substrate surface 102. First, a suitable apparatus is obtained, step 202. Then, the substrate surface 102 is pretreated, step 204. Initial parameters, such as carrier gas pressure, powder materials to be used, powder feed rate, and heater temperature, are selected, step 206. Next, cold-gas dynamic spraying is performed to form the graded coating 104 on the substrate surface 102, step 208. Post-coating processes are then performed, step 210.

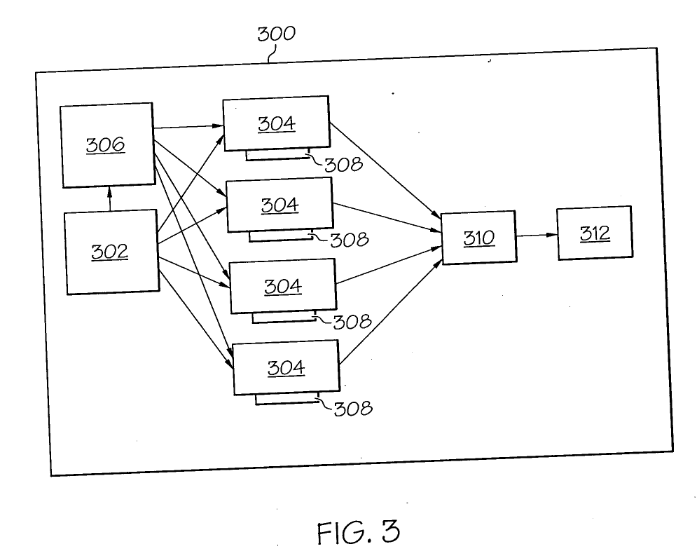

Preferably, a cold spraying system, such as the system depicted diagrammatically in FIG. 3 is employed to carry out the method 200. In one exemplary embodiment, the cold gas-dynamic spraying (hereinafter “cold spraying”) system 300 generally employs a suitably pressurized gas to transport a metal powder mixture out of a nozzle and onto a surface of the substrate 100. The system 300 shown in FIG. 3 is illustrated as a general scheme, and additional features and components can be implemented into the system 300 as necessary. The main components of the cold spraying system 300 include a controller 302, a plurality of powder feeds 304, a carrier gas supply 306, a plurality of heaters 308, a mixing chamber 310, and a convergent-divergent nozzle 312.

The controller 302 controls system parameters, such as the amount of carrier gas and the pressure of the gas in the system 300, and is coupled to the powder feeds 304 and carrier gas supply 306. The powder feeds 304 are configured to contain different component powders that will be mixed to form a desired powder mixture. The carrier gas supply 306 contains a conventionally used carrier gas such as air, helium or nitrogen for carrying the powder mixture through the system 300.

Each powder feed 304 is coupled to a heater 308 that is configured to warm the carrier gas and component powders to a suitable temperature. The mixing chamber 310 is configured to receive and mix the component powders to form the desired powder mixture. The nozzle 312 is coupled to the mixing chamber 310 the nozzle accelerates the powder to the required high velocities for cold spray. In one exemplary embodiment, the nozzle 312 is a Laval nozzle.

It will be appreciated that in other embodiments of the system 300, the mixing chamber 310 may not be included. In one exemplary embodiment, the powder feeds 304 and nozzle 312 are directly coupled to each other. For example, the powder feeds 304 may be situated upstream of the nozzle 312 and distributed equidistantly around an axis of the nozzle 312. In another exemplary embodiment, the powder feeds 304 are disposed such that they feed the powders directly upstream of the nozzle 312. Alternatively, the powder feeds 304 may be disposed such that they feed the powders into larger tube upstream of the nozzle 312 that is positioned on the same axis as the nozzle 312

Returning to FIG. 2 and with reference to FIG. 1, the substrate surface 102 may be pretreated in any one of numerous manners, step 204. In one exemplary embodiment, a solvent is applied to the substrate surface 102. For example, the substrate surface 102 is wiped with an alcohol swab. In another exemplary embodiment, the substrate surface 102 is grit-blasted to remove unwanted contaminants thereon. The grit-blast may be performed after alcohol is applied to the substrate surface 102. In still another embodiment, the substrate surface 102 is wiped with an alcohol swab after the grit-blast is performed. In still yet another embodiment, the coating 104 is formed from a mixture of particles having a range of hardnesses. Here, the controller 302 can be programmed to initially allow the harder particles to be fed through the nozzle 312 and to adjust system parameters, such as gas pressures and particle acceleration velocities, to those suitable for grit-blasting. Once the surface has been sufficiently grit blasted, the controller 302 readjusts the system parameters to those suitable for depositing the particles onto the surface and allows the softer and hard particles to be sprayed thereon.

Next, initial parameters are selected, step 206. As mentioned briefly above, the initial parameters may include the powder materials to be used, and apparatus parameters, such as the carrier gas pressure, the powder feed rate, and the heater temperature. It will be appreciated that the selection of each parameter is dependent upon the particular powder materials that will be deposited onto the substrate surface 102, and the powder material selection depends on the desired composition of the graded coating. It will be appreciated that the desired composition may include one or more constituents. For example, the composition may be an aluminum alloy or an aluminum-based alloy that also include copper, tungsten carbide, cobalt, silicon, silicon carbide, any other constituent, and any combination thereof. In any case, one or more of the constituents may make up a component of the powder mixture, and each component is individually placed into a powder feed 304.

After the powder materials are selected, initial parameters are then inputted into the cold spray system controller 302. For example, in processes in which aluminum alloys are used, the carrier gas pressure may be between about 100 psi and about 150 psi, the powder feed rate may be between about 3 g/sec and 5 g/sec, and the heater temperature may be between about 200° C. and about 500° C. Other parameters may also be selected, such as, for example, a nozzle 312 to substrate surface 102 distance or a raster rate (i.e. the rate at which the nozzle 312 moves across the substrate surface 102). Examples of suitable values include a distance of between about 5 mm and 10 mm, and a raster rate of between about 5 mm/sec. and 15 mm/sec.

Next, the system 300 is used in a cold-gas dynamic spraying process to form a graded coating 104 on the substrate 100, step 208. In one exemplary embodiment, the first section 106 of the graded coating 104 is deposited onto the substrate 100. In this regard, suitable amounts of the components used to make up the first section 106 are flowed from each appropriate powder feed 304 to the mixing chamber 310. In one exemplary embodiment, portions of the carrier gas are flowed at velocities that are each sufficient to carry respective predetermined portions of the components to the mixing chamber 310. It will be appreciated that each component may have a different density, thus the controller 302 is preferably appropriately pre-programmed to adjust the pressure of the carrier gas flow to each powder feed 304. Specifically, the pressure is adjusted to suitably carry the desired amount of component powder from the powder feed 304 to the mixing chamber 310. For example, in one exemplary embodiment, a first component has a higher density than a second component and a portion of the carrier gas flows through the first component at a first pressure, while another portion of the carrier gas flows through the second component at a second pressure that is greater than the first pressure.

After the appropriate amounts of components are dispensed in the mixing chamber 310, they are mixed to form a powder mixture that is suitable for forming the first section 106. The powder mixture is subsequently flowed to the nozzle 312 and deposited onto the substrate surface 102. As briefly mentioned above, the nozzle 312 may have any one of numerous configurations. Typically, the nozzle 312 will have a convergent/divergent shape, thereby including a high pressure region at its smallest diameter and a low pressure region at a larger diameter. It will be appreciated that the powder mixture may enter the nozzle 312 in any suitable portion thereof. In some embodiments, the powder mixture enters upstream of the nozzle 312. In another example, the powder mixture is flowed into a non-illustrated feed tube disposed upstream of the nozzle 312 and on the axis of the nozzle 312.

After the first section 106 is deposited onto the substrate surface 102, the second section 108 is then deposited thereover. As mentioned above, the second section 108 has a graded composition that gradually changes from the first composition to the second composition. In one exemplary embodiment, the controller 302 is pre-programmed to gradually change the ratio between the components in the powder feeds 304 while simultaneously causing the components to be deposited over the substrate surface 102. Thus, for example, in an embodiment in which the first composition includes a first component amount that is greater than a second component amount and the second composition includes a first component amount that is less than a second component amount, the first component amount is gradually decreased while the second component amount is gradually increased until the desired ratio is achieved between the two to form the second composition.

After the graded coating 104 is formed on the substrate surface 102, post-coating processes are performed, step 210. For example, the substrate 100 having the graded coating 104 thereon may be heat-treated to increase bonding between the component powders.

A method has now been provided for forming a graded coating that does not distort the substrate 100. Additionally, the method does not require the use of an apparatus that needs to be stopped and re-started each time the composition of the graded coating changes. Moreover, the method is generally inexpensive, efficient, and yields high quality graded coatings.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of forming a graded coating on a surface of a substrate, the method comprising the steps of:
forming a first powder mixture formulated to form a portion of the graded coating and comprising a first component and a second component, the step of forming a first powder mixture comprising:
flowing the first component through a first powder feed and flowing the second component through a second powder feed, wherein the first and second powder feeds are disposed upstream of a nozzle having an axis extending therethrough, the first and second powder feeds located around and equidistantly from the axis;
mixing the first and second components in a mixing chamber disposed between the first and second powder feeds and the nozzle to form the first powder mixture;
cold gas-dynamic spraying the first powder mixture on the substrate surface; and
gradually decreasing the first component and increasing the second component to form additional powder mixtures and cold gas-dynamically spraying the additional powder mixtures onto the substrate to form the graded coating thereon,
wherein the method is performed without generating a plasma.

2. (canceled)

3. (canceled)

4. The method of claim 1, following the first and second components from the first and second powder feeds into a feed tube disposed upstream of the nozzle and along the axis.

5. The method of claim 1, wherein the first component is disposed in a first powder feed, the second component is disposed in a second powder feed, and the first and second powder feeds are coupled to a controller configured to perform the steps of gradually decreasing and increasing.

6. The method of claim 5, further comprising the steps of:
flowing a first portion of a carrier gas over the first component at a velocity sufficient to carry a predetermined portion of the first component into a mixing chamber coupled to the first powder feed and the second powder feed; and
flowing a second portion of the carrier gas over the second component at a velocity sufficient to carry a predetermined portion of the second component into the mixing chamber.

7. The method of claim 6, wherein:
the first component has a higher density than the second component;
the step of flowing a first portion of a carrier gas comprises flowing the carrier gas at a first pressure; and
the step of flowing a second portion of the carrier gas comprises flowing the carrier gas at a second pressure that is greater than the first pressure.

8. The method of claim 1, further comprising pretreating the substrate surface before the step of cold gas-dynamic spraying.

9. The method of claim 8, wherein the step of pretreating comprises grit-blasting the substrate surface.

10. The method of claim 9, wherein the powder mixtures comprise a plurality of particles having a range of hardness and the step of grit-blasting the substrate surface comprises the steps of:
spraying a first portion of the plurality of particles at a predetermined gas pressure and a predetermined velocity, the first portion comprising particles having a hardness that is greater than the hardness of particles of a second portion of the plurality of particles; and
increasing the gas pressure and flowing the first and the second portion of the plurality of particles to form at least one of the powder mixtures.

11. The method of claim 1, wherein the powder mixtures comprise aluminum.

12. The method of claim 1, further comprising the step of heat treating the substrate to cause particles of the powder mixtures to bond to each other, after the step of gradually decreasing.

13. A method of forming a graded coating on a surface of a substrate, the method comprising the steps of:
cold gas-dynamic spraying a first powder mixture on the substrate surface, the first powder mixture formulated to form a first portion of the graded coating and comprising a first component and a second component; and
gradually decreasing the first component and increasing the second component to form additional powder mixtures, while cold gas-dynamic spraying the additional powder mixtures over the portion of the graded coating to form a second portion of the graded coating,
wherein the method is performed without generating a plasma.

14. The method of claim 13, wherein the first component is disposed in a first powder feed, the second component is disposed in a second powder feed, and the first and second powder feeds are coupled to a controller configured to perform the step of gradually decreasing.

15. The method of claim 14, further comprising the steps of:
flowing a first portion of a carrier gas over the first component at a velocity sufficient to carry a predetermined portion of the first component into a mixing chamber coupled to the first powder feed and the second powder feed; and
flowing a second portion of the carrier gas over the second component at a velocity sufficient to carry a predetermined portion of the second component into the mixing chamber.

16. The method of claim 15, wherein:
the first component is has a higher density than the second component;
the step of flowing a first portion of a carrier gas comprises flowing the carrier gas at a first pressure; and
the step of flowing a second portion of the carrier gas comprises flowing the carrier gas at a second pressure that is greater than the first pressure.

17. The method of claim 13, further comprising pretreating the substrate surface before the step of cold gas-dynamic spraying the first powder mixture.

18. The method of claim 17, wherein the step of pretreating comprises grit-blasting the substrate surface.

19. The method of claim 13, further comprising the step of heat treating the substrate to cause particles of the powder mixtures to bond to each other, after the step of cold gas-dynamic spraying additional powder mixtures.

20. A method of forming a graded coating on a surface of a substrate, the method comprising the steps of:
cold gas-dynamic spraying a first powder mixture on the substrate surface to form a first portion of the graded coating;
decreasing a first component of the first powder mixture and increasing a second component of the first powder mixture to form additional powder mixtures, while cold gas-dynamic spraying the additional powder mixtures on the substrate surface over the first layer to form a second portion of the graded coating; and
repeating the step of decreasing and cold-gas spraying the additional powder mixtures over the substrate to form other portions of the graded coating until a top portion having a predetermined composition is formed,
wherein the method is performed without generating a plasma.
